(19) United States
(12) Patent Application Publication
(10) Pub. No.: US 2016/0326335 A1
(43) Pub. Date: Nov. 10, 2016

(54) METHOD FOR FORMING AN AROMATIC DIACID AND/OR AN AROMATIC DIACID PRECURSOR FROM A POLYESTER-CONTAINING FEEDSTOCK

(71) Applicant: BP Corporation North America Inc., Naperville, IL (US)

(72) Inventors: Gregory E. Schmidt, Batavia, IL (US); Thomas Bartos, Arden, NC (US); Ajay Joshi, Aurora, IL (US); Anders Larsen-Bitsch, Wheaton, IL (US); Peter Metelski, Penfield, NY (US); Daniel Leonardi, Oswego, IL (US)

(73) Assignee: BP Corporation North America Inc., Naperville, IL (US)

(21) Appl. No.: 15/109,165

(22) PCT Filed: Dec. 30, 2014
(86) PCT No.: PCT/US14/72637

§ 371 Date: Jun. 30, 2016

Related U.S. Application Data
(60) Provisional application No. 61/922,154, filed on Dec. 31, 2013.

(51) Int. Cl. C08J 11/24; C08G 63/183; C08J 11/14

(52) U.S. Cl. CPC C08J 11/24; C08J 11/14; C08G 63/183; C08J 2367/02

(57) ABSTRACT

A method for forming an aromatic diacid and/or an aromatic diacid precursor from a polyester-containing feedstock. The method comprises contacting the polyester-containing feedstock with water or an alcohol to depolymerize the polyester and thereby form an aromatic diacid and/or an aromatic diacid precursor, wherein the polyester-containing feedstock comprises about 80 wt % or more polyester and about 1 wt % or more of at least one secondary material, and wherein the at least one secondary material is not polyester.

### CROSS-REFERENCE TO RELATED APPLICATIONS

This application claims the benefit of U.S. Provisional Application No. 61/922,154, filed Dec. 31, 2013.

### BACKGROUND

Polyester is used in a variety of applications, in particular, in films, bottles, and food containers. Current techniques allow, colorless, transparent poly(ethylene terephthalate) (PET) containers, such as bottles for soft drinks, to be recycled economically. In the recycling process, PET containers are sorted into different colors and baled. Baled containers made from clear and green PET are washed, flaked, and dried to form clean PET flakes. If necessary, the clean, clear PET flakes can be processed to remove any impurities (i.e., any component other than clean, clear PET flake and/or green PET flake).

Polyester is used in a variety of applications, in particular, in films, bottles, and food containers. Current techniques allow, colorless, transparent poly(ethylene terephthalate) (PET) containers, such as bottles for soft drinks, to be recycled economically. In the recycling process, PET containers are sorted into different colors and baled. Baled containers made from clear and green PET are washed, flaked, and dried to form clean PET flakes. If necessary, the clean, clear PET flakes can be processed to remove any impurities (i.e., any component other than clean, clear PET flake and/or green PET flake).

The recycling of clean PET flakes can include depolymerization to break the ester bonds of the PET and reduce the polymer to its monomer components. Depolymerization can occur using several known reaction pathways, including, for example, via methanolysis or ethanolysis.

Another portion of materials sorted at a reclamation facility, known as post-consumer mixed rigids and post-consumer polyester carpets, are largely under-utilized in recycling efforts and are thought to have zero or negative economic value. Moreover, these materials contain increased amounts of non-polyester components (e.g., colorants, fillers, non-PET polymers) compared to clean, clear PET flake and green PET flake and, as such, are potentially unsuitable and/or deleterious to current reclamation processes.

Methods for producing copolyesters with high level's of recycled content have been proposed. In a particular process, scrap or post-consumer poly(ethylene terephthalate) is depolymerized by methanolysis or glycolysis to produce purified, recycled dimethyl terephthalate, which can be repolymerized with two or more dials. However, in this process it is necessary to remove non-polyester decontaminants in the scrap or post-consumer PET before the depolymerization step.

Thus, despite these current efforts to recycle clean, clear PET, it will be appreciated that there is a continued need in the art for methods of efficiently recycling polyester-containing feedstocks, including bio-derived feedstocks, not currently utilized due their high non-polyester contents. Furthermore, it is desirable to use purified recycled monomers obtained from depolymerization reactions to produce polyester, especially polyester suitable for direct food contact.

### SUMMARY

The invention provides a method for forming an aromatic diacid and/or an aromatic diacid precursor from a polyester-containing feedstock, which method comprises contacting the polyester-containing feedstock with water or an alcohol to depolymerize the polyester and thereby form an aromatic diacid and/or an aromatic diacid precursor, wherein the polyester-containing feedstock comprises about 60 wt % or more polyester and about 1 wt % or more of at least one secondary material, and wherein the at least one secondary material is not polyester.

The invention further provides a method of forming terephthalic acid (rTA) from an aromatic diacid precursor.

According to another aspect of the invention, the invention provides a method for forming an aromatic diacid and/or an aromatic diacid precursor from a polyester-containing feedstock, which method comprises contacting the polyester-containing feedstock with water or an alcohol to depolymerize the polyester and thereby form an aromatic diacid and/or an aromatic diacid precursor, wherein depolymerizing the polyester includes contacting the polyester-containing feedstock with a catalyst comprising one or more materials selected from PVC, a polyamide, and combinations thereof.

According to another aspect of the invention, the invention provides a method for forming an aromatic diacid and/or an aromatic diacid precursor from a polyester-containing feedstock, which method comprises contacting the polyester-containing feedstock with water or an alcohol to depolymerize the polyester and thereby form an aromatic diacid and/or an aromatic diacid precursor, wherein the polyester-containing feedstock additionally comprises at least one secondary material which is not a polyester, and wherein prior to depolymerizing the polyester, the amount of polyester relative to the at least one secondary material is increased in the feedstock by removing at least a portion of the at least one secondary material from the feedstock by differentially dissolving the polyester and the at least one secondary material in an ionic liquid and separating the dissolved and undissolved materials.

According to another aspect of the invention, the invention provides a method for forming an aromatic diacid and/or an aromatic diacid precursor from a polyester-containing feedstock, which method comprises contacting the polyester-containing feedstock with water or an alcohol to depolymerize the polyester and thereby form an aromatic diacid and/or an aromatic diacid precursor, wherein depolymerizing the polyester includes contacting the polyester-containing feedstock with a catalyst comprising an ionic liquid.

According to another aspect of the invention, the invention provides a method for forming an aromatic diacid and/or an aromatic diacid precursor from a polyester-containing feedstock, which method comprises contacting the polyester-containing feedstock with water or an alcohol to depolymerize the polyester and thereby form an aromatic diacid and/or an aromatic diacid precursor, wherein depolymerizing the polyester includes contacting the polyester-containing feedstock with a catalyst, and wherein the catalyst comprises one or more materials that forms an azoetrope with the alcohol or water used to depolymerize the polyester.

According to another aspect of the invention, the invention provides a method for forming an aromatic diacid and/or an aromatic diacid precursor from a polyester-containing feedstock, which method comprises contacting the polyester-containing feedstock with water or an alcohol to depolymerize the polyester and thereby form an aromatic diacid and/or an aromatic diacid precursor, wherein depolymerizing the polyester includes contacting the polyester-containing feedstock with a catalyst and deactivating the catalyst after depolymerization of at least a significant proportion of the polyester.

Other aspects of the invention will be apparent to those skilled in the art in view of the description that follows.

### BRIEF DESCRIPTION OF THE DRAWINGS

For a more complete understanding of the disclosure, reference should be made to the following detailed description and the drawings wherein:

FIG. 1 is a flow diagram illustrating an embodiment of a method for forming an aromatic diacid and/or an aromatic diacid precursor from a polyester-containing feedstock;

FIG. 2 is a flow diagram illustrating another embodiment of a method of the invention;

FIG. 3 is a flow diagram illustrating another embodiment of the method of the invention;

FIG. 4 is a flow diagram illustrating an embodiment of the invention for forming an aromatic diacid from a polyester-containing feedstock, and using the aromatic diacid to produce fresh polyester material.

### DETAILED DESCRIPTION

The invention seeks to provide a method of recycling a polyester-containing feedstock, particularly a polyester-containing feedstock that was heretofore left as landfill waste due to its high content of non-polyester materials. In particular, the invention provides a method for forming an aromatic diacid and/or an aromatic diacid precursor from a polyester-containing feedstock. The method comprises contacting the polyester-containing feedstock with water or an alcohol to depolymerize the polyester and thereby form an aromatic diacid and/or aromatic diacid precursor. The polyester-containing feedstock comprises about 60 wt % or more polyester and about 1 wt % or more of at least one secondary material, wherein the at least one secondary material is not polyester.

The aromatic diacid precursor can be any suitable aromatic diacid precursor. For example, the aromatic diacid precursor can be dimethyl terephthalate (DMT), diethyl terephthalate (DET), methyl-2-hydroxyethyl-terephthalate (MHET), bis-hydroxyethyl terephthalate (BHET), and/or mono-methyl terephthalate (MMT). Similarly, the aromatic diacid can be any suitable aromatic diacid, such as terephthalic acid (TA).

The alcohol is any suitable alcohol which reacts with a polyester-containing feedstock to form an aromatic diacid and/or aromatic diacid precursor. For example, the alcohol can be a C₁₋₃ alcohol (e.g., methanol, ethanol, propanol, or isopropanol). The alcohol can also be a diol, such as ethylene glycol. In some embodiments, the alcohol is methanol, such that the aromatic diacid precursor is DMT. In other instances, the alcohol is ethanol, and the aromatic diacid precursor is DET. The alcohol can be recycled, if desired, during any method step described herein. In a preferred embodiment, the alcohol is a liquid solvent and is not used as a gas or supercritical fluid.

In certain embodiments, when the polyester-containing feedstock is contacted with water, an aromatic diacid, such as terephthalic acid (rTA), is formed directly. Alternatively, an aromatic diacid precursor can be formed via contact with alcohol first (e.g., DMT) and then contacted with water to hydrolyze the precursor. With certain aromatic diacid precursors, the precursor will be hydrolyzed to form rTA. If desirable, the hydrolyzed aromatic diacid precursor can be reacted further (e.g., oxidized) to form rTA. The rTA formed in any of the methods described herein can optionally be blended with any suitable amount of virgin terephthalic acid (vTA). Any suitable amount (e.g., 0% to 100%) of the vTA can be bio-derived. In a preferred embodiment, at least 1% of the vTA is bio-derived.

The amount of water or alcohol needed can vary, depending on the specific composition of the polyester-containing feedstock. In general, the water will be added in 5 to 10 parts per part of the polyester-containing feedstock (including any range of water encompassed within). The alcohol will be added in 5 to 10 parts per part of the polyester-containing feedstock (including any range of alcohol encompassed within).

The step of contacting the polyester-containing feedstock with water or alcohol can be performed under any suitable reaction conditions and can be performed as either a batch, continuous, or semi-continuous process using at least one suitable depolymerization vessel. For example, a temperature range of 150-265° C., preferably 160-200° C. or 160-190° C., can be used. The temperature is such that the terephthalic acid derivatives are in the liquid or melt phase. The reactions can take place under pressurized conditions (e.g., at least 2 MPa, at least 3 MPa, at least 4 MPa, as well as less than 5 MPa, less than 7 MPa). Reaction times will vary depending on the components of the polyester-containing feedstock and the depolymerizing solvent. Typical reaction times will be at least 1 hour (e.g., at least 2 hours, at least 3 hours, at least 4 hours, and at least 5 hours, as well as less than 10 hours, less than 8 hours, less than 5 hours, and less than 3 hours). In some cases, the only solvent in the depolymerization system will be water and/or alcohol. In one embodiment, no additional solvent (e.g., a polyester precursor, such as DMT, DET, or MHET, or an alkylene diol, such as ethylene glycol) is added to the system. In another embodiment (which can be in addition to the preceding embodiment), an alkaline compound, such as an alkali metal hydroxide (e.g., NaOH, KOH, LiOH, Ca(OH)₂, or Mg(OH)₂), is not added to the system as a reactant. In a further alternative embodiment, an ionic liquid can be added to the polyester-containing feedstock before the depolymerization step.

Hydrolyzing an aromatic diacid precursor to form rTA can take place under any suitable reaction conditions and can be performed as either a batch, continuous, or semi-continuous process. For example, the operating temperature will generally be between 50-300° C., and preferably will be between 200-230° C., Typically the hydrolysis reaction will take place under pressure (e.g., at least 2 MPa, at least 3 MPa, at least 4 MPa, as well as less than 5 MPa, less than 7 MPa). During the hydrolysis process, alcohol is formed as a side product (e.g., MeOH, EtOH). If desired, such alcohol can be recovered and reused for the depolymerization reaction.

Prior to any subsequent reactions using the aromatic diacid and/or aromatic diacid precursor (e.g., hydrolysis), the diacid and/or precursor can be isolated from side products (e.g., ethylene glycol) and/or solvent. Any suitable method can be used to isolate the aromatic diacid and/or aromatic diacid precursor, including filtration, distillation (e.g., azeotropic distillation), extraction, crystallization, and sublimation. Preferably, the aromatic diacid and/or aromatic diacid precursor is isolated using distillation. In a specific example, after reaction with water or alcohol, the reaction mixture can be filtered to remove solid impurities. Any remaining water or alcohol can be removed and recycled to the depolymerization vessel. The aromatic diacid and/or aromatic diacid precursor can be distilled to isolate it from any dissolved impurities.

In some embodiments, an azeotropic distillation is required to isolate the aromatic diacid and/or aromatic diacid precursor, and more than one distillation columns and/or an entrainer can be used. Typical entrainers include, for example, methylbenzoate, ethylbenzoate, p-methyltoluate, tetralin, dimethyl naphthalene dicarboxylate, monomethyl naphthalene dicarboxylate, monomethyl isophthalate, p-toluic acid, and combinations thereof. Preferably, the entrainer is selected from the group consisting of methylbenzoate, ethylbenzoate, p-methyltoluate, tetralin, and combinations thereof. An entrainer can be used in any suitable amount, such as about 0.40 to 0.60 parts per part of the aromatic diacid and/or aromatic diacid precursor (e.g., about 0.40 to 0.55, about 0.45 to 0.60, about 0.45 to 0.55, about 0.5 to 0.6, etc.). In a specific example, an entrainer can be used to break the azeotrope between DMT and ethylene glycol. Once purified DMT is isolated, the ethylene glycol and entrainer can be processed. For instance, the ethylene glycol can be purified and employed for suitable uses, whereas the entrainer can be recycled back to the distillation pot for additional distillations.

The polyester-containing feedstock comprises any polyester or copolyester typically found in a material recycling facility and/or post-consumer polymer source. For example, the feedstock can comprise post-consumer mixed rigids (e,g., polyester bottles and thermoforms), post-consumer polyester carpet, or a combination thereof. The feedstock preferably comprises post-consumer mixed rigids, optionally comprising, for example, polyethylene terephthalate (PET), polyethylene terephthalate glycol modified (PETG), polyethylene naphthalate (PEN), polybutylene terephthalate (PET), polylactic acid (PLA), polycarbonate, and combinations thereof. In an embodiment, the polyester comprises polyester resin, for example, which has repeating structural units containing residues of isophthalic acid, terephthalic acid, naphthalene dicarboxylic acid (e.g., 2,6-, 1,4-, 1,5-, 2,7-, 1,2-, 1,3-, 1,6-, 1,7-, 1,8-, 2,3-, 2,4-, 2,5-, and/or 2,8-substituted), 4,4′-oxybis(benzoic acid), and/or 5-tert-butyl-1,3-benzene dicarboxylic acid. Particularly useful are polyester resins which have repeating structural units containing residues of terephthalic acid or a naphthalene dicarboxylic acid (e.g., 2,6-naphthalene dicarboxylic acid). Accordingly, the polyester preferably comprises or consists essentially of poly(ethylene terephthalate) (PET), poly(ethylene naphthalate), or a combination thereof. Preferably, the polyester comprises or consists essentially of PET.

The polyester-containing feedstock comprises about 60 wt % or more polyester. In certain embodiments, the feedstock will comprise more than 60 wt % polyester (e.g., about 70 wt % or more, about 75 wt % or more, about 80 wt % or more, about 85 wt % or more, about 90 wt % or more, about 95 wt % or more). Typically, the feedstock will comprise about 8 wt % or less (e.g., 7 wt % or less, about 6 wt % or less, about 5 wt % or less, about 4 wt % or less, about 3 wt % or less, about 2 wt % or less, or about 1 wt % or less) of terephthalic acid as a discrete molecule. In another embodiment (which can be in addition to the preceding embodiment), the feedstock will comprise about 5 wt % or less (e.g., about 4 wt % or less, about 3 wt % or less, about 2 wt % or less, or about 1 wt % or less) of green PET flake.

If desired, the amount of polyester relative to the at least one secondary material can be increased in the feedstock prior to depolymerizing the aromatic diacid precursor. Any suitable method can be used to increase the amount of polyester in the feedstock. Typically, the amount of polyester in the feedstock is increased by removing at least a portion of the at least one secondary material from the feedstock. In some embodiments of the invention, the amount of polyester relative to the at least one secondary material is increased only to levels at which at least 1 wt % secondary materials (in total) are present in the feedstock; i.e. the total proportion of polyester is not increased above 99 wt %. A secondary material can be removed from the feedstock by a process such as air elutriation, a sorting process, a float-sink process, and/or a process comprising differentially dissolving the polyester and the at least one secondary material in an ionic liquid and separating the dissolved and undissolved materials. Sorting processes include, for example, automatic bottle sortation, flake sortation, ball milling, and screening. A float-sink process enables the separation of certain polymers with densities that differ from polyester, e.g., polyolefins.

Use of an ionic liquid takes advantage of the differences in solubilites therein of polyethylenes and common impurities, such as polyolefins and PVC. For example, where the polyester in the polyester-containing feedstock is more soluble in a particular ionic liquid than the principle contaminants in the feedstock, adding the ionic liquid to the feedstock will preferentially dissolve the polyester, and all, or a selected proportion, of the undissolved contaminants may be removed by filtering, before depolymerization of the polyester. Alternatively, where the aromatic diacid and/or aromatic diacid precursor produced in the depolymerization reaction is more soluble than the principle contaminants in the feedstock, the ionic liquid may be added before or after the depolymerization step, and the contaminants can be removed from the resultant aromatic diacid and/or aromatic diacid precursor by filtration and/or allowing the contaminants to settle out, before further processing of the aromatic diacid and/or precursor.

The term “ionic liquid” as used herein refers to a liquid that is capable of being produced by melting a salt, and when so produced consists solely of ions. An ionic liquid may be formed from a homogeneous substance comprising one species of cation and one species of anion, or it can be composed of more than one species of cation and/or more than one species of anion. Thus, an ionic liquid may be composed of more than one species of cation and one species of anion. An ionic liquid may further be composed of one species of cation, and one or more species of anion. Still further, an ionic liquid may be composed of more than one species of cation and more than one species of anion.

The term “ionic liquid” includes compounds having both high melting points and compounds having low melting points, e.g. at or below room temperature. Thus, many ionic liquids have melting points below 200° C., preferably below 150° C., particularly below 100° C., around room temperature (15 to 30° C.), or even below 0° C. Ionic liquids having melting points below around 30° C. are commonly referred to as “room temperature ionic liquids” and are often derived from organic salts having nitrogen-containing heterocyclic cations, such as imidazolium and pyridinium-based cations. In room temperature ionic liquids, the structures of the cation and anion prevent the formation of an ordered crystalline structure and therefore the salt is liquid at room temperature.

Ionic liquids are most widely known as solvents, because of their negligible vapour pressure, temperature stability, low flammability and recyclability. Due to the vast number of anion/cation combinations that are available it is possible to fine-tune the physical properties of the ionic liquid (e.g. melting point, density, viscosity, and miscibility with water or organic solvents) to suit the requirements of a particular application.

Any suitable ionic liquid can be employed in the present invention. For example, the ionic liquid cation can be an imidazolium, pyridinium or ammonium species, and the anion can be a halide, tetrafluroborate, hexaflurophosphate, bistriflimide, triflate or tosylate species.

In preferred embodiments of the invention, in addition to comprising about 60 wt % or more polyester, the feedstock comprises about 1 wt % or more of at least one secondary material (e.g., about 2 wt % or more, about 3 wt % or more, about 5 wt % or more, about 7 wt % or more, about 10 wt % or more, about 12 wt % or more, or about 15 wt % or more), based on the weight of the feedstock. As an upper limit, the feedstock preferably comprises about 40 wt % or less of at least one secondary material. These values represent the total amount of all the secondary materials. The amount of each individual secondary material will vary depending on the source of the polyester feedstock. Typically, each secondary material will be present in an amount of about 0.1 wt % or more (e.g., about 0.2 wt % or more, about 0.25 wt % or more, about 0.5 wt % or more, about 1 wt % or more, about 1.5 wt % or more, about 2 wt % or more, about 2.5 wt % or more, about 3 wt % or more, about 4 wt % or more, about 5 wt % or more, or about 10 wt % or more) based on the weight of the feedstock. Alternatively, or in addition, each secondary material can be present in the feedstock in an amount of about 15 wt % or less (e.g., about 12 wt % or less, about 10 wt % or less, about 9 wt % or less, about 8 wt % or less, about 7 wt % or less, about 6 wt % or less, about 5 wt % or less, about 4 wt % or less, about 3 wt % or less, about 2 wt % or less, about 1.8 wt % or less, about 1.6 wt % or less, about 1.4 wt % or less, about 1.3 wt % or less, about 1.2 wt % or less, about 1.1 wt % or less, about 1 wt % or less, about 0.9 wt % or less, about 0.8 wt % or less, about 0.7 wt % or less, about 0.6 wt % or less, about 0.5 wt % or less, about 0.4 wt % or less, about 0.3 wt % or less, or about 0.2 wt % or less), based on the weight of the feedstock. Thus, the amount of each secondary material can be bounded by any two of the foregoing endpoints.

The at least one secondary material is typically a polymer, including high density (>1.0 g/cc) and low density (<1.0 g/cc) polymers, and can include inorganic components (e.g., a colorant, a filler, a flame retardant, a stain resistant agent, a glue, or a metal). In certain embodiments, the at least one secondary material comprises at least one material selected from the group consisting of high density polyethylene (HDPE), polyethylene (PE), polypropylene (PP), polystyrene (PS) (including crystal and impact modified), polycarbonate (PC), ethylene vinyl alcohol (EVOH), poly(ethylene vinyl alcohol), polylactic acid (PLA), polyglycolic acid, poly(hydroxy butyrate), a synthetic rubber (e.g., ethylene propylene diene monomer (EPDM), polybutadienes, acrylics), poly(ethylene-2,5-furan dicarboxylic acid), and combinations thereof. For example, the feedstock can comprise polycarbonate (PC), polylactic acid (PLA), polystyrene, polyethylene (including high density, medium density, and/or low density), and/or polypropylene.

In certain aspects, the at least one secondary material comprises at least one (e.g., two or more, three or more, or four or more) materials, each being present in the amount of 0.25 wt % or more in the feedstock, and each selected from the group consisting of a filled polyolefin, an unfilled polyolefin, a chlorinated polymer, polystyrene, a filled polyamide, an unfilled polyamide, a polymer used as a barrier coating for packaging, and combinations thereof. In one embodiment, the at least one secondary material comprises at least one (e.g., two or more, three or more, or four or more) materials, each being present in the amount of 0.25 wt % or more in the feedstock, and each selected from the group consisting of polyvinyl chloride (PVC), high density polyethylene (HDPE), polyethylene (PE), polypropylene (PP), polystyrene (PS), polycarbonate (PC), nylon MXD6 (MXD6), ethylene vinyl alcohol (EVOH), poly(ethylene vinyl alcohol), polylactic acid (PLA), polyglycolic acid, poly(hydroxy butyrate), a synthetic rubber, poly(ethylene-2,5-furan dicarboxylic acid), and combinations thereof. In certain embodiments, the feedstock comprises three or more secondary materials. Preferably, the secondary material comprises PVC, nylon MXD6, or a combination thereof.

The at least one secondary material can be neat (a pure entity without any filler) or comprise a filler, such as an inorganic filler. A typical inorganic filler comprises at least one material selected from the group consisting of titanium dioxide, titanium nitride, wollastonite, montmorillonite clay, calcium carbonate, and combinations thereof.

In some embodiments of the invention, the polyester is depolymerized in the presence of one or more ionic liquids. The use of ionic liquids provides a number of potential advantages, including the direct depolymerization of polyesters to aromatic diacids. For example, if polyethylene terephthalate is dissolved in an ionic liquid and water is added, the polyethylene terephthalate is depolymerized efficiently to form terephthalate acid and ethylene glycol, and the two products can be easily separated; the terephthalate acid being removed by solid/liquid separation and the remaining filtrate being easily distilled, to separate ethylene glycol, water and the ionic liquid, which can then be recycled in the process. Additionally, as polyesters may be dissolved in ionic liquids at relatively low temperatures and pressures, the hydrolysis/depolymerization reaction can be carried out at lower temperatures and/or pressures than, for example, a methanolysis reaction, and will therefore be less energy intensive. Consequently, reactors may have higher throughput, and a relatively small reactor can be used.

In some cases, the ionic liquid will act as a catalyst for the depolymerization step but, optionally, a Lewis Acid may additionally be used. Suitable Lewis Acids include zinc chloride, zinc acetate, magnesium chloride, magnesium acetate, ammonium chloride, boron fluoride, boron chloride, boron bromide, titanium chloride and combinations thereof. Any suitable ionic liquid may be used, as discussed herein.

If desired, depolymerizing the polyester can include contacting the polyester-containing feedstock with a catalyst.

In some embodiments, the catalyst may comprise one or more materials that form an azeotrope with the alcohol or water used to depolymerize the Polyester. Advantages associated with using catalysts that form azeotropes with the water or alcohol used to depolymerize the polyester include, ease of separation of the catalyst from the aromatic diacid and/or aromatic diacid precursor produced in the depolymerization, thereby preventing the catalyst from catalyzing the formation of undesirable byproducts from the aromatic diacid and/or precursor. For example, if the catalyst used to form dimethyl terephthalate in a methanolysis reaction is not quickly separated from the dimethyl terephthalate it will tend to cause the dimethyl terephthalate and residual ethylene glycol to react to from undesirable by-products, including methyl-(2-hydroxyethyl) terephthalate and bis-hydroxyethyl terephthalate. Any suitable catalyst that promotes the depolymerization of polyester and forms an azeotrope with the depolymerization solvent may be used. An example of a suitable azeotrope forming catalyst is methyl acetate, which may be used alone or in combination with other compounds, including sodium hydroxide, sodium acetate and zinc acetate.

In general, the catalyst is any suitable metal-based compound that promotes the hydrolysis or alcoholysis reaction, particularly a metal-based compound and/or methyl acetate. Suitable metals include those selected from Group 1, 2, 7, 8, 9, 10, 11, or 12 of the periodic table. Typically, the catalyst comprises a Lewis Acid and/or methyl acetate and/or at least one metal acetate from the periodic table. In certain embodiments, the catalyst comprises a Lewis Acid and/or methyl acetate and/or at least one metal acetate wherein the metal is selected from Group 1, 2, 7, or 12 of the periodic table. Examples of suitable catalysts include methyl acetate, sodium acetate, lithium acetate, manganese acetate, cobalt acetate, palladium acetate, copper acetate, and zinc acetate. Preferably, the catalyst comprises zinc acetate.

The catalyst can be present in any suitable amount that is effective for depolymerizing the polyester-containing feedstock. Typically, the catalyst will be present in 0.025 to 0.075% based on the weight of the feedstock.

As discussed herein, once an aromatic diacid and/or aromatic diacid precursor is formed from a polyester, it may react further to produce unwanted by-products, particularly if a metal salt is used to catalyze the depolymerization. One method for preventing or reducing the production of by-products, is to remove the catalyst from the aromatic diacid or precursor as quickly as possible, but this is not always possible. An alternative option therefore, is to deactivate the catalyst. A particularly suitable means for deactivating the catalyst includes converting it to an insoluble, and therefore relatively inactive, form; and this also assists in removal of the deactivated catalyst, for example by filtration or settling out. Deactivation of the catalyst may be achieved in various different ways, depending upon the nature of the catalyst. For example, where the catalyst comprises a TiO²⁺ salt, it may be deactivated by the addition of ethylenediaminetetraaceticacid (EDTA) to form an insoluble TiO(EDTA) complex. Alternatively, if the catalyst is titanium oxyacetylacetonate, it may be deactivated by the addition of water, which hydrolyses the catalyst to an insoluble titanium oxide. Similarly, where the catalyst comprises a cobalt salt or a zinc salt, deactivation of a catalyst may be carried out by adding a soluble oxylate salt, to form an insoluble cobalt or zinc oxylate salt.

The catalyst can also comprise one or more catalyzing impurities in the feedstock. In other words, it is believed that certain secondary materials can act as a catalyst for the depolymerization reaction. In some embodiments of the invention, the catalyst comprises no material (e.g., a metal acetate) other than the catalyzing impurities in the feedstock. Preferable materials with catalyzing-type activity include, for example, PVC, a polyamide, and combinations thereof. The polyamide can comprise, for example, nylon MXD6, nylon 6, nylon 6,6, or an amorphous aromatic-aliphatic nylon prepared from at least (i) a diacid group selected from terephthalic acid, isophthalic acid, a naphthalene dicarboxylic acid (e.g., 2,6-, 1,4-, 1,5-, 2,7-, 1,2-, 1,3-, 1,6-, 1,7-, 1,8-, 2,3-, 2,4-, 2,5-, and/or 2,8-substituted), and 2,5-furandicarboxylic acid and (ii) a diamine group selected from hexamethylenediamine, 2,4,4-trimethyl hexamethylene diamine, and 2-methyl-1,5-pentamethylene diamine. Preferably, the polyamide comprises at least nylon MXD6.

Optionally, the aromatic diacid and/or aromatic diacid precursor formed in the process of the present invention may be used to form fresh polyester material. For example, terephthalate acid either formed directly by the depolymerization of the polyester-containing feedstock, or produced from a precursor produced in the depolymerization process, may be combined with a suitable material, such as monoethylene glycol, to form polyethylene terephthalate. As a further option, terephthalate acid produced in the process of the present invention may be blended with virgin terephthalate acid, and the resulting mixture may be further combined with monoethyl glycol to form polyethylene terephthalate.

In certain embodiments of the invention, at least a portion of the energy used in the method is derived from one or more renewable energy sources. Suitable renewable energy sources include wind, solar, nuclear, hydroelectric, geothermal and physiokinetic energy. Alternatively or additionally, the method of the invention may be intergrated with one or more processes that produce excess energy. By utilizing renewable energy sources as well as integrating highly energy efficient chemical processes, the carbon dioxide footprint of the overall process may be reduced or even eliminated.

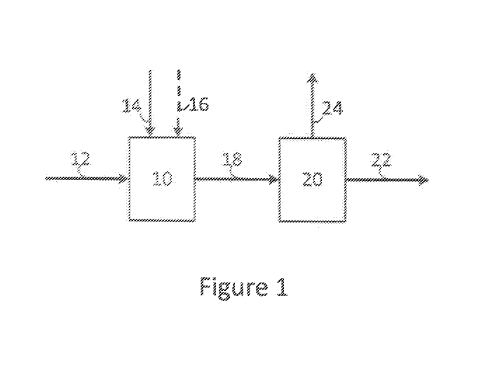

In the embodiment illustrated in FIG. 1, a depolymerisation unit 10 receives a polyester-containing feedstock 12. The polyester-containing feedstock 12 comprises 60 wt % or more polyester and 1% or more of at least one secondary material which is not a polyester. The depolymerisation unit 10 also receives a water or alcohol stream 14, and the polyester-containing feedstock 12 and the water or alcohol stream 14 are mixed in the depolymerisation unit 10 under conditions suitable for the depolymerisation of the polyester to form an aromatic diacid and/or an aromatic diacid precursor. Suitably, the conditions for depolymerisation include a temperature in the range of 150-265° C. and a pressure of at least 2 MPa. Optionally, a catalyst 16 is supplied to the depolymerisation unit 10. Where used, the catalyst comprises any compound suitable to catalyse the depolymerisation of the polyester, such as methyl acetate, a Lewis Acid or a metal acetate. Alternatively or additionally, one or more of the secondary components in the polyester-containing feedstock 12 may act as a depolymerisation catalyst (for example, PVC and/or one or more polyamides, such as nylon MXD6). Once a significant portion of the polyester has been depolymerized (for example, after from 1 to 10 hours) a product stream 18, comprising an aromatic diacid and/or an aromatic diacid precursor, is removed from the reactor 10. The product stream 18 may be removed in substantially pure form, or may comprise additional products of the depolymerisation reaction (for example a glycol such as ethylene glycol) and unreacted starting materials, including polyester, secondary materials, alcohol and water.

Optionally, the product stream 18 may be provided to a separating unit 20, such as a distillation unit, filtration unit, crystallization unit or a sublimation unit. The product stream 18 is separated in the separation unit 20 to produce a relatively purified product stream 22, comprising an aromatic diacid and/or aromatic diacid precursor, and a side product and/or solvent stream 24, comprising unreacted depolymerisation solvent (alcohol and/or water) and polymerization by-products, such as ethylene glycol.

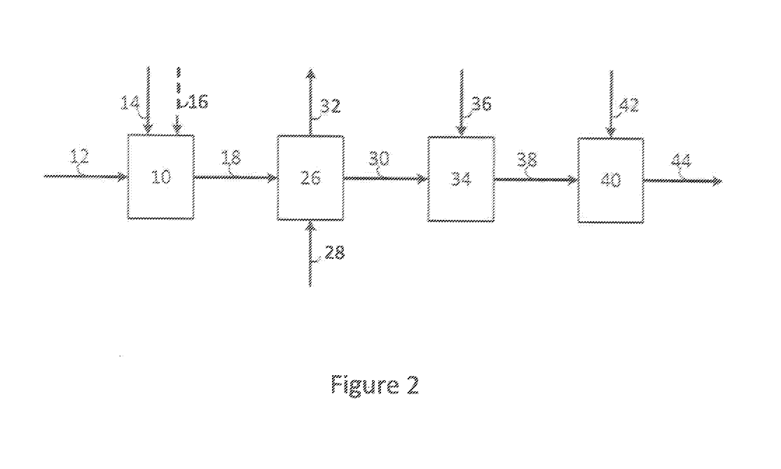

In the embodiment illustrated in FIG. 2, a polyester-containing feedstock 12 is provided to a depolymerisation unit 10, as discussed with respect to FIG. 1. An alcohol or water stream 14 is also provided to the depolymerisation unit 10, and optionally a catalyst 16 is also provided. The product stream 18 is supplied to a distillation unit 26, which may be, for example, an azeotropic distillation unit, which is also provided with an entrainer stream 28. Suitable entrainers include methylbenzoate, ethylbenzoate, p-ethyltoluate, tetralin, dimethyl naphthalene di-carboxylate, monomethyl naphthalene dicarboxylate, monomethyl isophthalate, p-toluic acid and combinations thereof. In the distillation unit 26, the product stream 18 is separated into a relatively purified product stream 30 and a solvent by-product stream 32. Where the relatively purified product stream 30 comprises an aromatic diacid precursor, it may be supplied to a hydrolysis unit 34, which is also provided with a water stream 36. In the hydrolysis unit 34, the aromatic diacid precursor is hydrolyzed to form an aromatic diacid, which is removed as product stream 38. Optionally, the aromatic diacid stream 38 is provided to reactor unit 40, which is also supplied with a glycol stream 42. In the reactor 40, the aromatic diacid and glycol are reacted to form a polyester, which is removed from the reactor 40 as polyester product stream 44. As an example, if the aromatic diacid stream 38 comprises terephthalic acid and the glycol stream 42 comprises mono-ethylene glycol, the polyester product stream 44 will comprise polyethylene terephthalate.

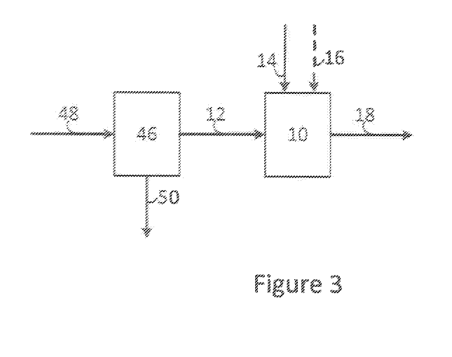

In the embodiment shown in FIG. 3, a relatively low polyester content feedstock 46, for example, comprising less than 60 wt % polyester and greater than 40% secondary components, is provided to pre-separation unit 46. Pre-separation unit 46 may comprise an air elutriation system, a sorting process or a float-sink process. Pre-separation unit 46 may alternatively comprise a system in which an ionic liquid is mixed with the low polyester content feedstock 48 to differentially dissolve the polyester and the one or more secondary materials, and means to separate the dissolved and undissolved materials. At least a portion of the secondary materials are removed from the pre-separation unit 46 as waste stream 50, and a polyester containing feedstock 12 comprising 60% or more polyester and 1% or more secondary materials is also removed and provided to depolymerisation unit 10, where it is processed, for example, as discussed with respect to FIG. 1 and FIG. 2.

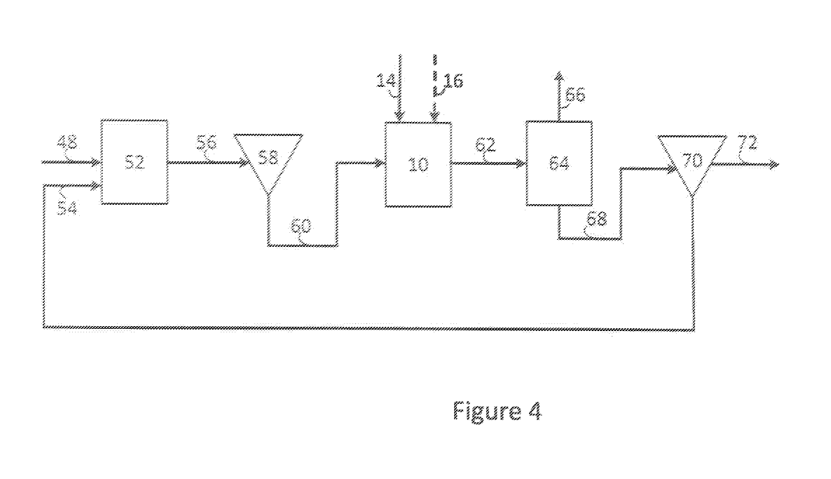

In the embodiment illustrated in FIG. 4, a relatively low polyester content feed stream 48, for example, comprising less than 60% polyester and greater than 40% secondary material, is provided to mixing unit 52, where it is mixed with ionic liquid stream 54. Ionic liquid stream 54 may also comprise water and/or one or more catalysts. The polyester (for example polyethylene terephthalate) in relatively low polyester content feed stream 48 is dissolved in the ionic liquid, whilst at least a portion of the secondary materials are not dissolved. A mixture of dissolved polyester and un-dissolved secondary materials 56 is removed from mixing unit 52, and supplied to filtration system 58, where it is separated into a feed stream 60 comprising polyester and secondary materials dissolved and/or suspended in ionic liquid and, optionally, water. The proportion of polyester and secondary materials is 60 wt % or more and 1 wt % or more, respectively. Feed stream 60 is supplied to a depolymerisation unit 10, where optionally, additional water 14 and/or catalyst 16 is also provided. The polyester is depolymerized under suitable conditions, for example as discussed with respect to FIG. 1, in depolymerisation unit 10, to form an aromatic diacid, such as terephthalic acid. Product stream 62, comprising terephthalic acid, water, ethylene glycol and ionic liquid, is removed from depolymerisation unit 10, and supplied to separation unit 64, which may be, for example, a distillation unit. In separation unit 64, the feed stream 62 is separated to remove ethylene glycol and a portion of the water as water/ethylene glycol stream 46, and to form relatively purified product stream 68, comprising terephthalic acid, ionic liquid and water. Relatively purified product stream 68 is provided to crystallization unit 70, and terephthalic acid is crystalized out and removed as terephalic acid stream 72. Residual water and ionic liquid removed from crystallization unit 70 may be recycled to mixing unit 52 as stream 54. The terephthalic acid 72 removed from crystallization unit 70, may be further processed, for example by blending with additional terephthalic acid and/or by reaction with monoethylene glycol to form polyethylene terephthalate.

The following examples further illustrate the invention but, of course, should not be construed as in any way limiting its scope.

### EXAMPLE 1

This example demonstrates the depolymerization of a polyester-containing feedstock with methanol and the subsequent preparation of rTA in an embodiment of the invention.

A feedstock comprising the following components in Table 1 was placed in a batch reactor with an excess of methanol and 0.025 wt % zinc acetate based on rPET waste added at 160-200° C. and 1700-3900 kPa (17-39 bar) for 1-3 h.

TABLE 1

| | Wt % |
|---|---|
| | (based on |
| | total |
| Component | composition) |
| PET | ≧90 |
| PVC | ≦1 |
| PLA and PC | ≦3 |
| Polymers other than PVC, | ≦3 |
| PLA, or PC with density >1.0 g/cc | |
| Polymers with density <1.0 g/cc | ≦1 |
| (PS, PE, PP) | |
| Inorganic fillers (e.g., | ≦2 |
| colorants, fillers) | |

After the reaction was stopped, the product stream was filtered to separate out solid non-PET impurities (e.g., PE, PP, etc.) at 109° C. and 500 kPa (5 bar). The solid waste was removed, and methanol was recycled back to the depolymerization reactor for subsequent use.

The depolymerization products, DMT and ethylene glycol, underwent an azeotropic distillation in the presence of an entrainer. Purified DMT was drawn off from the bottom, whereas the ethylene glycol/entrainer mixture came off the top. The ethylene glycol/entrainer mixture was separated by decanting ethylene glycol from the top, which was then purified for future use. The entrainer was returned to the distillation pot.

The purified DMT was reacted with water at 200-230° C. and 1600-3000 kPa (16-30 bar) for 1-2 h to form rTA.

The purified DMT was reacted with water at 200-230° C. and 1600-3000 kPa (16-30 bar) for 1-2 h to form rTA. The yield of rTA from the recovered DMT and subsequent hydrolysis was 92%.

### EXAMPLE 2

This example demonstrates the effect of the presence of PVC and a zinc acetate catalyst on a PET feedstock in the production of dimethyl terephthalate (DMT).

The reactor was charged with 80 g of PET, 640 g methanol, and varying degrees of PVC and zinc acetate (Table 2). The methanolysis reaction was run at 230° C. under 6.5 MPa (950 psig) for 3 h. At the end of the reaction, the contents were recovered and analyzed for the presence of dimethyl terephthalate (DMT). The results are shown in Table 2.

TABLE 2

| | zinc acetate | |
|---|---|---|
| PVC (grams) | (wt %) | DMT yield (%) |
| 0.0 | 0.0 | 36.8 |
| 1.0 | 0.0 | 80.4 |
| 1.0 | 1.0 | 87.0 |

As shown in Table 2, the presence of both PVC and the zinc acetate improved the DMT yield relative to a PET feedstock without PVC and/or zinc acetate.

### EXAMPLE 3

This example demonstrates the effect of various catalysts on a PET feedstock in the production of aromatic diacid precursors in an embodiment of the invention.

A feedstock comprising 150 g PET was combined with 750 g methanol in the presence of various catalysts. The methanolysis reaction was run at different reaction temperatures under 6.5 MPa (950 psig) for 1 h. At the end of the reaction, the contents were recovered and analyzed for the presence of dimethyl terephthalate (DMT), methylhydroxy-ethylterephthalate (MHET), and monomethyl terephthalate (MMT). The results are shown in Table 3.

TABLE 3

| | | | | | Yield |
|---|---|---|---|---|---|
| | | Temp. | Yield DMT | Yield MHET | MMT |
| Entry | Catalyst | (° C.) | (mol %) | (mol %) | (mol %) |
| 1 | none | 180 | 0.4 | 0.2 | 0.0 |
| 2 | Zn(Ac)₂ | 180 | 90.9 | 4.1 | 0.4 |
| 3 | LiOH | 180 | 10.2 | 7.3 | 0.5 |
| 4 | Ca(OH)₂ | 180 | 44.9 | 16.7 | 0.7 |
| 5 | Fe(Ac)₂ | 180 | 2.1 | 2.5 | 0.2 |
| 6 | TiO(acac)₂ | 180 | 90.0 | 4.1 | 0.4 |
| 7 | Co(Ac)₂ | 180 | 46.3 | 19.2 | 0.6 |
| 8 | Mn(Ac)₂ | 180 | 62.5 | 16.6 | 0.6 |
| 9 | Mg(Ac)₂ | 180 | 4.8 | 2.2 | 0.2 |
| 10 | CaSO₄ | 180 | 5.4 | 6.5 | 0.2 |
| 11 | Zn(Ac)₂ | 180 | 90.9 | 4.0 | 0.4 |
| | CaSO₄ | | | | |
| 12 | TiO(acac)₂ | 180 | 91.7 | 4.0 | 0.3 |
| | CaSO₄ | | | | |
| 13 | Zn(Ac)₂ | 200 | 90.9 | 4.0 | 0.4 |
| 14 | LiOH | 200 | 55.3 | 24.5 | 1.2 |
| 15 | Ca(OH)₂ | 200 | 86.6 | 5.4 | 0.8 |
| 16 | Fe(Ac)₂ | 200 | 46.4 | 27.3 | 1.1 |
| 17 | TiO(acac)₂ | 200 | 91.7 | 4.0 | 0.4 |
| 18 | Co(Ac)₂ | 200 | 88.6 | 4.4 | 0.6 |
| 19 | Mn(Ac)₂ | 200 | 89.3 | 4.5 | 0.6 |
| 20 | Mg(Ac)₂ | 200 | 31.7 | 28.7 | 1.1 |
| 21 | CaSO₄ | 200 | 0.8 | 1.8 | 0.4 |
| 22 | Zn(Ac)₂ | 200 | 90.2 | 309 | 0.4 |
| | CaSO₄ | | | | |
| 23 | MeAc (5 g) | 230 | 54.4 | 23.3 | 5.1 |
| 24 | MeAc (25 g) | 230 | 50.8 | 25.0 | 2.9 |
| 25 | MeAc (40 g) | 230 | 70.9 | 13.7 | 4.4 |
| 26 | MeAc (190 g) | 230 | 87.5 | 3.0 | 0.6 |
| | ZnAc | | | | |

As shown in Table 3, zinc acetate and titanium oxide acetylacetone (acac) (see, e.g., entries 2, 11-13, 17, and 22) show high catalytic activity in the methanolysis of a PET-containing feedstock to produce an aromatic diacid precursor, such as DMT.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method for forming an aromatic diacid and/or an aromatic diacid precursor from a polyester-containing feedstock, which method comprises contacting the polyester-containing feedstock with water or an alcohol to depolymerize the polyester and thereby form an aromatic diacid and/or an aromatic diacid precursor, wherein the polyester-containing feedstock comprises about 60 wt % or more polyester and about 1 wt % or more of at least one secondary material, and wherein the at least one secondary material is not polyester.

2. The method of claim 1, wherein the aromatic diacid precursor is at least one of dimethyl terephthalate (DMT), diethyl terephthalate (DET), methyl-2-hydroxyethyl-terephthalate (MHET), bis-hydroxyethyl terephthalate (BHET), and mono-methyl terephthalate (MMT).

3. The method of claim 1 [or claim 2], wherein the alcohol is methanol.

4. The method of claim 1 [3 or any one of claims 1-3], wherein the aromatic diacid precursor is DMT.

5. The method of claim 1 [4 or any one of claims 1-4], wherein the aromatic diacid precursor is contacted with water to hydrolyze the precursor.

6. The method of claim 1 [or claim 2], wherein the alcohol is ethanol.

7. The method of claim 5, wherein prior to hydrolyzing the aromatic diacid precursor, the precursor is isolated via distillation.

8. (canceled)

9. The method of claim 7 [or claim 8], wherein the distillation utilizes an entrainer.

10. The method of claim 9, wherein the entrainer is selected from the group consisting of dimethyl naphthalene dicarboxylate, monomethyl naphthalene dicarboxylate, monomethyl isophthalate, p-toluic acid, methylbenzoate, ethylbenzoate, p-methyltoluate, tetralin, and combinations thereof.

11. The method of claim 1 [or any of claims 1-10], wherein the polyester comprises at least one material selected from the group consisting of polyethylene terephthalate (PET), polyethylene terephthalate glycol-modified (PETG), polyethylene naphthalate (PEN), polybutylene terephthalate (PET), and combinations thereof.

12. The method of claim 1 [or any one of claims 1-11], wherein the feedstock comprises about 75 wt % or more polyester.

13. The method of claim 1 [or any one of claims 1-12], wherein the feedstock comprises about 90 wt % or more polyester.

14. The method of claim 1 [or any one of claims 1-13], wherein the feedstock comprises post-consumer mixed rigids.

15. The method of claim 1 [any one of claims 1-12], wherein the amount of polyester relative to the at least one secondary material is increased in the feedstock prior to depolymerizing the aromatic diacid precursor.

16. (canceled)

17. The method of claim 15 [or claim 16], wherein the amount of polyester is increased by a process selected from the group consisting of air elutriation, a sorting, process, a float sink process, and a process comprising differentially dissolving the polyester and the at least one secondary material in an ionic liquid and separating the dissolved and undissolved materials.

18-19. (canceled)

20. The method of claim 1 [or any one of claims 1-19], wherein the at least one secondary material comprises at least one material selected from the group consisting of high density polyethylene (HDPE), polyethylene (PE), polypropylene (PP), polystyrene (PS), polycarbonate (PC), ethylene vinyl alcohol (EVOH), poly(ethylene vinyl alcohol), polylactic acid (PLA), polyglycolic acid, poly(hydroxy butyrate), a synthetic rubber, poly(ethylene-2,5-furan dicarboxylic acid), and combinations thereof.

21. The method of claim 1 [or any one of claims 1-19], wherein the at least one secondary material comprises at least three materials, each being present in the amount of 0.25 wt % or more in the feedstock, each selected from the group consisting of a filled polyolefin, an unfilled polyolefin, a chlorinated polymer, polystyrene, a filled polyamide, an unfilled polyamide, a polymer used as a barrier coating for packaging, and combinations thereof.

22. The method of claim 21 [or any one of claims 1-19 and claim 21], wherein the at least one secondary material comprises at least three materials, each being present in the amount of 0.25 wt % or more in the feedstock, each selected from the group consisting of polyvinyl chloride (PVC), high density polyethylene (HDPE), polyethylene (PE), polypropylene (PP), polystyrene (PS), polycarbonate (PC), nylon MXD6 (MXD6), ethylene vinyl alcohol (EVOH), poly(ethylene vinyl alcohol), polylactic acid (PLA), polyglycolic acid, poly(hydroxy butyrate), a synthetic rubber, poly(ethylene-2,5-furan dicarboxylic acid) and combinations thereof.

23. The method of claim 21 [or any one of claims 20-22], wherein the at least one secondary material comprises an inorganic filler.

24-29. (canceled)

30. The method of claim 28 [or claim 29], wherein the catalyst comprises catalyzing impurities in the feedstock.

31. The method of claim 30, wherein the catalyzing impurities comprise one or more materials selected from PVC, a polyamide, and combinations thereof.

32-34. (canceled)

35. The method of claim 28 [or claim 29 or any one of claims 28-33], wherein the catalyst comprises a Lewis Acid and/or methyl acetate and/or at least one metal acetate from Group 1, 2, 7, 8, 9, 10, 11 or 12 of the periodic table.

36-44. (canceled)

45. The method of [claim 43 or] claim 44 further comprising combining the rTA with monoethylene glycol to form polyethylene terephthalate (PET).

46. The method of [claim 43 or] claim 44 further comprising blending the rTA with virgin terephthalic acid (vTA).

47. The method of claim 46 further comprising combining the rTA and vTA with monoethylene glycol to form polyethylene terephthalate (PET).

48. The method of claim 1 [or any one of claims 1-47], wherein at least a portion of the energy used in the method is derived from one or more renewable energy sources.

49. (canceled)

50. The method of claim 1 [or any one of claims 1-49], wherein the method is integrated with one or more processes that produce excess energy.

51-70. (canceled)
